(19) United States
(12) Patent Application Publication
(10) Pub. No.: US 2023/0024097 A1
(43) Pub. Date: Jan. 26, 2023

(54) DRIVING SUPPORT SYSTEM, DRIVING SUPPORT METHOD, AND STORAGE MEDIUM

(71) Applicant: TOYOTA JIDOSHA KABUSHIKI KAISHA, Toyota-shi (JP)

(72) Inventor: Takeshi BABA, Nisshin-shi (JP)

(73) Assignee: TOYOTA JIDOSHA KABUSHIKI KAISHA, Toyota-shi (JP)

(21) Appl. No.: 17/868,895

(22) Filed: Jul. 20, 2022

(30) Foreign Application Priority Data
Jul. 26, 2021 (JP) 2021-121381

(51) Int. Cl. B60W 30/09; B60W 30/095; B60W 30/14; B60W 40/04; B60W 10/20

(52) U.S. Cl. CPC B60W 30/09; B60W 30/0956; B60W 30/146; B60W 40/04; B60W 10/20; B60W 2556/20; B60W 2556/40

(57) ABSTRACT

A driving support system includes: an information acquisition unit configured to acquire traveling characteristic information on a vehicle; a storage unit in which a dynamic map is stored, the dynamic map being a map in which static base map information, dynamic environmental information, and the traveling characteristic information acquired by the information acquisition unit are associated with each other; a collision determination unit configured to determine whether or not there is a possibility that the vehicle has a collision, based on the dynamic map stored in the storage unit; and a control unit configured to, in a case where the collision determination unit determines that there is a possibility that the vehicle has a collision, control the vehicle such that the vehicle avoids the collision.

### CROSS-REFERENCE TO RELATED APPLICATION

This application claims priority to Japanese Patent Application No. 2021-121381 filed on Jul. 26, 2021, incorporated herein by reference in its entirety.

### BACKGROUND

### 1. Technical Field

The present disclosure relates to a driving support system, a driving support method, and a storage medium each for supporting driving of a vehicle.

### 2. Description of Related Art

There has been known a system in which specific information and position information to specify a host vehicle are transmitted to another vehicle, and a collision risk is determined based on specific information and position information transmitted from another vehicle (e.g., see Japanese Unexamined Patent Application Publication No. 2018-049530 (JP 2018-049530 A)).

### SUMMARY

In the above-described system, the determination on a collision of a vehicle is not performed in consideration of a traveling characteristic such as a braking characteristic that varies depending on vehicles. On this account, it might be difficult to accurately determine a collision.

The present disclosure is achieved in order to solve such a problem, and a main object of the present disclosure is to provide a driving support system, a driving support method, and a storage medium each of which can determine a collision of a vehicle with high accuracy and can enhance safety.

One aspect of the present disclosure to achieve the above object is a driving support system including an information acquisition unit, a storage unit, a collision determination unit, and a control unit. The information acquisition unit is configured to acquire traveling characteristic information on a vehicle. In the storage unit, a dynamic map is stored. The dynamic map is a map in which static base map information, dynamic environmental information, and the traveling characteristic information acquired by the information acquisition unit are associated with each other. The collision determination unit is configured to determine whether or not there is a possibility that the vehicle has a collision, based on the dynamic map stored in the storage unit. The control unit is configured to, in a case where the collision determination unit determines that there is a possibility that the vehicle has a collision, control the vehicle such that the vehicle avoids the collision.

In the one aspect, the traveling characteristic information may include at least one of information indicative of whether or not the vehicle has a deceleration control function, a maximum deceleration speed of the vehicle, an idle running time of the vehicle, information indicative of whether or not the vehicle has a steering control function, and a minimum turning radius of the vehicle.

In the one aspect, the traveling characteristic information may include information indicative of whether or not the vehicle has a deceleration control function, a maximum deceleration speed of the vehicle, and information indicative of whether or not the vehicle has a steering control function. The collision determination unit may determine whether or not a first vehicle avoids a collision with a second vehicle by performing a deceleration control, by use of an equation including the maximum deceleration speed of the vehicle based on the dynamic map associated with the traveling characteristic information. In a case where the collision determination unit determines that the first vehicle does not avoid the collision with the second vehicle by performing the deceleration control, the control unit may perform a steering control on the first vehicle such that the first vehicle avoids the second vehicle, based on the traveling characteristic information.

One aspect of the present disclosure to achieve the above object is a driving support method including: a step of acquiring traveling characteristic information on a vehicle; a step of storing a dynamic map in which static base map information, dynamic environmental information, and the traveling characteristic information are associated with each other; a step of determining whether or not there is a possibility that the vehicle has a collision, based on the dynamic map thus stored; and a step of, in a case where it is determined that there is a possibility that the vehicle has a collision, controlling the vehicle such that the vehicle avoids the collision.

One aspect of the present disclosure to achieve the above object is a non-transitory storage medium storing a program to cause a computer to execute the following processes: a process of acquiring traveling characteristic information on a vehicle; a process of storing a dynamic map in which static base map information, dynamic environmental information, and the traveling characteristic information are associated with each other; a process of determining whether or not there is a possibility that the vehicle has a collision, based on the dynamic map thus stored; and a process of, in a case where it is determined that there is a possibility that the vehicle has a collision, controlling the vehicle such that the vehicle avoids the collision.

With the present disclosure, it is possible to provide a driving support system, a driving support method, and a storage medium each of which can determine a collision of a vehicle with high accuracy and can enhance safety.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram illustrating a schematic system configuration of a driving support system according to the present embodiment;

FIG. 2 is a block diagram illustrating a schematic system configuration of a vehicle according to the present embodiment;

FIG. 3 is a block diagram illustrating a schematic system configuration of a control server according to the present embodiment; and

FIG. 4 is a flowchart illustrating the procedure of a driving support method according to the present embodiment.

### DETAILED DESCRIPTION OF EMBODIMENTS

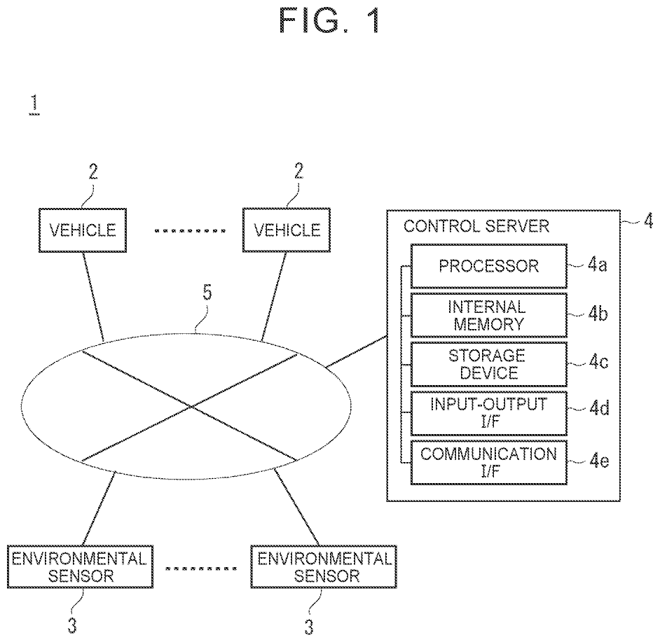

With reference to drawings, the following describes an embodiment of the present disclosure. FIG. 1 is a block diagram illustrating a schematic system configuration of a driving support system according to the present embodiment. A driving support system 1 according to the present embodiment includes a plurality of vehicles 2 traveling on a road or the like, a plurality of environmental sensors 3 configured to detect environmental information around each vehicle, and a control server 4 configured to control the vehicles 2.

The vehicles 2, the environmental sensors 3, and the control server 4 perform information communication with each other via a wireless communication network 5, for example.

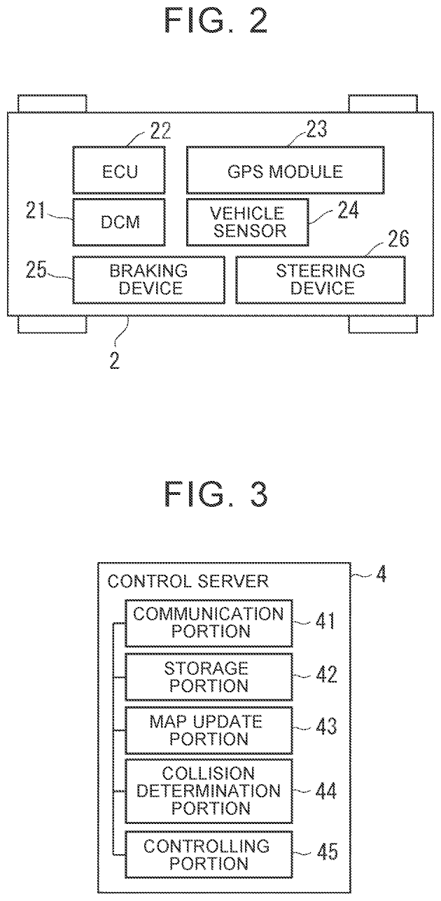

FIG. 2 is a block diagram illustrating a schematic system configuration of a vehicle according to the present embodiment.

The vehicle 2 includes a data communication module (DCM) 21, an electronic control unit (ECU) 22, a global positioning system (GPS) module 23, and a vehicle sensor 24.

The DCM 21 is an example of a communication device configured to perform bidirectional communication with the control server 4 via the wireless communication network 5 including a cellular telephone network, the Internet network, or the like with a lot of base stations being taken as terminals. The DCM 21 is mutually communicably connected to various ECUS 22 via an in-vehicle network such as a controller area network (CAN).

The ECU 22 is an electronic control unit configured to perform various control processes for predetermined functions in the vehicle 2. The ECU 22 performs a process of transmitting information (traveling characteristic information) on the traveling characteristic of the vehicle 2 to the control server 4 via the DCM 21.

The traveling characteristic information includes at least any one of information indicative of whether or not the ECU 22 of the vehicle 2 has a deceleration control function, a maximum deceleration speed Gmax of the vehicle 2, an idle running time of the vehicle 2, information indicative of whether or not the ECU 22 of the vehicle 2 has a steering control function, and a minimum turning radius of the vehicle 2.

The maximum deceleration speed Gmax is a value set for each vehicle 2 based on conditions such as a weight of the vehicle 2, a loading state of the vehicle 2, an occupant state (the number of occupants) in the vehicle 2, a type (attribute) of the vehicle 2, and the like. The ECU 22 calculates the maximum deceleration speed Gmax based on the loading state of the vehicle 2, the occupant state in the vehicle 2, and so on that are detected by the vehicle sensor 24.

The idle running time may be found experimentally in advance and may be set by the ECU 22 in advance. The minimum turning radius may not be just a catalogue value and may be a controllable value and set by the ECU 22 in advance, for example.

The ECU 22 automatically performs a deceleration control on the vehicle 2 by controlling a braking device 25 configured to brake wheels of the vehicle 2. The ECU 22 automatically performs a steering control on the vehicle 2 by controlling a steering device 26 configured to steer the wheels of the vehicle 2.

The ECU 22 transmits (uploads) position information on the vehicle 2 to the control server 4 via the DCM 21 for every predetermined period. The position information on the vehicle 2 is input from the GPS module 23. At this time, in addition to the position information on the vehicle 2, the ECU 22 transmits, to the control server 4, time information corresponding to the position information and attribute information (a passenger vehicle, a commercial vehicle, a bus, a motorcycle, or the like) on the vehicle 2.

The GPS module 23 receives GPS signals transmitted from three or more, preferably four or more satellites positioned above the vehicle and measures the position of the vehicle 2 in which the GPS module 23 is provided. The GPS module 23 is connected to the ECU 22 communicably via an in-vehicle network such as a one-on-one communication line or a CAN. The position information on the vehicle 2 thus measured is input into the ECU 22.

The vehicle sensor 24 includes a camera, a millimeter wave sensor, or the like configured to capture an image around the vehicle 2, e.g., a predetermined image range ahead of the vehicle 2. The camera is attached to a central upper end part of a front window of the vehicle 2 on a side facing the inner side of a vehicle cabin, that is, a central part, in the right-left direction, of a front header inside the vehicle cabin of the vehicle 2, for example.

The DCM 21 transmits, to the control server 4 via the wireless communication network 5, a captured image captured by the camera, and position information on the vehicle 2 and time information at the time when the captured image is captured. The position information on the vehicle 2 and the time information are input from the GPS module 23. Note that the DCM 21 may transmit, to the control server 4 via the wireless communication network 5, distance information from a millimeter wave sensor, a light detection and ranging (LiDAR) sensor, or the like of the vehicle 2 together with the position information on the vehicle 2 and the time information.

As illustrated in FIG. 1, the environmental sensor 3 detects environmental information on a road where the vehicle 2 travels or the like. The environmental sensor 3 is attached to an infrastructure such as a traffic light, a telephone pole, or a sign. The environmental sensor 3 is, for example, a camera, a millimeter wave sensor, a LiDAR sensor, or the like. The environmental sensor 3 transmits the environmental information such as a surrounding captured image to the control server 4 via the wireless communication network 5. At this time, in addition to the environmental information, the environmental sensor 3 transmits time information corresponding to the environmental information and position information on the environmental sensor 3 to the control server 4 via the wireless communication network 5.

The control server 4 controls the vehicle 2. The control server 4 has a hardware configuration of a normal computer including, for example, a processor 4a such as a central processing unit (CPU) or a graphics processing unit (GPU), an internal memory 4b such as a random access memory (RAM) or a read only memory (ROM), a storage device 4c such as a hard disk drive (HDD) or a solid state drive (SDD), an input-output I/F 4d to which a peripheral device such as a display is connected, and a communication I/F 4e configured to communicate with external equipment.

FIG. 3 is a block diagram illustrating a schematic system configuration of a control server according to the present embodiment. The control server 4 according to the present embodiment includes a communication portion 41, a storage portion 42, a map update portion 43, a collision determination portion 44, and a controlling portion 45.

The communication portion 41 is a device configured to bidirectionally communicate with the vehicle 2 and the environmental sensor 3 via the wireless communication network 5. The communication portion 41 is one concrete example of an information acquisition unit. The communication portion 41 acquires traveling characteristic information on the vehicle 2 from the vehicle 2. The communication portion 41 is a mobile communication module corresponding to a communications standard such as Long Term Evolution (LTE), 5th-Generation (5G), or 6th-Generation (6G), for example.

The storage portion 42 is one concrete example of a storage unit. In the storage portion 42, a dynamic map in which static base map information is associated with dynamic environmental information is stored. The dynamic map is a dynamic map in which dynamic environmental information (additional information) including objects (e.g., stores, facilities, vehicles, and the like) at given positions, phenomena (e.g., accidents, traffic jam, lines of people, and the like), and states thereof are associated with static base map information including geographic information on natural objects such as mountains, rivers, and seas, and artifacts such as buildings and roads. A region targeted for the dynamic map may be all over Japan or may be a particular region such as a region inside a distribution center, for example.

Further, in the dynamic map according to the present embodiment, the static base map information, the dynamic environmental information, and the traveling characteristic information acquired by the communication portion 41 are associated with each other. More specifically, in the base map information, respective pieces of traveling characteristic information are associated with the vehicles 2 traveling on a base map.

The map update portion 43 updates the dynamic map stored in the storage portion 42 for every predetermined period, for example. The map update portion 43 updates the dynamic map in the storage portion 42 based on position information on the vehicle 2, time information, and attribute information that are transmitted from the ECU 22 of the vehicle 2.

The map update portion 43 updates the dynamic map in the storage portion 42 based on a captured image transmitted from the camera of the vehicle 2, position information, and time information. The map update portion 43 updates the dynamic map in the storage portion 42 based on a captured image, position information, and time information that are transmitted from the environmental sensor 3.

Further, the map update portion 43 may also update the dynamic map based on position information and time information transmitted from a portable terminal such as a smartphone that is possessed by a user. The map update portion 43 may update the dynamic map in the storage portion 42 based on a captured image, position information, and time information that are transmitted from the portable terminal.

In the meantime, in a case where the determination on a collision of a vehicle is not performed in consideration of a traveling characteristic such as a braking characteristic that varies depending on vehicles, it might be difficult to accurately determine a collision of a vehicle.

In the meantime, as described above, the collision determination portion 44 according to the present embodiment determines whether or not there is a possibility that the vehicle 2 has a collision, by use of the dynamic map in which the static base map information, the dynamic environmental information, and the traveling characteristic information acquired by the communication portion 41 are associated with each other. Hereby, it is possible to determine a collision of the vehicle 2 with high accuracy and to enhance safety in consideration of the traveling characteristic of the vehicle 2.

The collision determination portion 44 is one concrete example of a collision determination unit. The collision determination portion 44 determines whether or not there is a possibility that the vehicle 2 collides with an obstacle, based on the dynamic map stored in the storage portion 42. The obstacle includes, for example, another vehicle, a motorcycle, a bicycle, people, an installed object, and so on.

The collision determination portion 44 acquires respective pieces of position information and respective pieces of speed information on the vehicles 2 from the dynamic map in the storage portion 42. The collision determination portion 44 detects vehicles 2 coming closer to each other based on the respective pieces of position information on the vehicles 2.

For example, a first vehicle a approaches a second vehicle b performing a linear uniform motion, from its diagonally rear side. The control server 4 shall support driving of the vehicle a. The position coordinate of the vehicle a is expressed as Xa, and the position coordinate of the vehicle b is expressed as Xb. The collision determination portion 44 detects the vehicles a, b that satisfy the following condition, based on the dynamic map in the storage portion 42.

|Xa−Xb|<predetermined distance A

Further, the collision determination portion 44 determines whether or not the vehicle a can avoid a collision with the vehicle b by performing a deceleration control, by use of the following quadratic equation for time-to-collision T₀. Note that Xa represents the vehicle speed of the vehicle a, and Xb represents the vehicle speed of the vehicle b. Further, Ga, Va, Vb, Xa, Xb represent three-dimensional vector quantities.

−½×Ga×T₀²+(Va−Vb)×T₀+Xa−Xb=0

The collision determination portion 44 solves the quadratic equation for T₀ in the range of 0<Ga<Gmax. In a case where the quadratic equation for T₀ has a positive solution that is not a complex number, the collision determination portion 44 determines that the vehicle a cannot avoid a collision with the vehicle b by performing the deceleration control, and there is a possibility that the vehicle a may collide with the vehicle b.

In the meantime, in a case where the quadratic equation for T₀ has a complex solution or a negative solution that is not a complex number, the collision determination portion 44 determines that the vehicle a can avoid a collision with the vehicle b by performing the deceleration control, and there is no possibility that the vehicle a may collide with the vehicle b. Thus, the collision determination portion 44 can determine a collision between the vehicles 2 with high accuracy in consideration of the traveling characteristics of the vehicles 2 that include the maximum deceleration speeds Gmax, thereby making it possible to enhance safety.

The controlling portion 45 is one concrete example of a control unit. In a case where the collision determination portion 44 determines that there is a possibility that vehicles may collide with each other, the controlling portion 45 controls the vehicle 2 such that the vehicle 2 avoids the collision between the vehicles.

In order to avoid the collision between the vehicles, the controlling portion 45 selects at least one of a deceleration control and a steering control, based on the traveling characteristic information on the vehicle 2, for example. The traveling characteristic information includes, for example, information indicative of whether or not the ECU 22 of the vehicle 2 has a deceleration control function, and information indicative of whether or not the ECU 22 of the vehicle 2 has a steering control function. Accordingly, based on the traveling characteristic information, the controlling portion 45 selects a function which the ECU 22 of the vehicle 2 has and which is optimum, from the deceleration control function and the steering control function.

In a case where the deceleration control is selected, the controlling portion 45 calculates a deceleration speed (braking force) for the deceleration control. In a case where the steering control is selected, the controlling portion 45 calculates a vehicle steering angle by steering.

The controlling portion 45 controls the vehicle 2 by transmitting a selected control signal to the ECU 22 of the vehicle 2 via the communication portion 41 and the wireless communication network 5. In a case where the deceleration control is selected, the controlling portion 45 transmits a control signal to the ECU 22 of the vehicle 2 so that the deceleration control is performed at the calculated deceleration speed. In a case where the steering control is selected, the controlling portion 45 transmits a control signal to the ECU 22 of the vehicle 2 so that the steering control is performed at the calculated vehicle steering angle.

For example, as described above, in a case where the collision determination portion 44 determines that the vehicle a cannot avoid a collision with the vehicle b by performing the deceleration control, and there is a possibility that the vehicle a may collide with the vehicle b, the collision determination portion 44 transmits the determination result to the controlling portion 45.

The controlling portion 45 selects the steering control based on the determination result from the collision determination portion 44 and transmits a control signal to the ECU 22 of the vehicle a so that the steering control is performed at a vehicle steering angle by which the vehicle a avoids the vehicle b. The ECU 22 of the vehicle a controls the steering device 26 in response to the control signal from the controlling portion 45, so that the vehicle a avoids the collision with the vehicle b.

Note that the controlling portion 45 may select the steering control based on the determination result from the collision determination portion 44 and may transmit a control signal to the ECU 22 of the vehicle a so that the deceleration control is performed while the steering control is performed at the vehicle steering angle by which the vehicle a avoids the vehicle b.

In the meantime, in a case where the collision determination portion 44 determines that the vehicle a can avoid a collision with the vehicle b by performing the deceleration control, and there is no possibility that the vehicle a may collide with the vehicle b, the collision determination portion 44 transmits the determination result to the controlling portion 45.

The controlling portion 45 selects the deceleration control based on the determination result from the collision determination portion 44 and transmits a control signal to the ECU 22 of the vehicle a so that the deceleration control is performed to avoid the collision with the vehicle b. The ECU 22 of the vehicle a controls the braking device 25 in response to the control signal from the controlling portion 45, so that the vehicle a avoids the collision with the vehicle b.

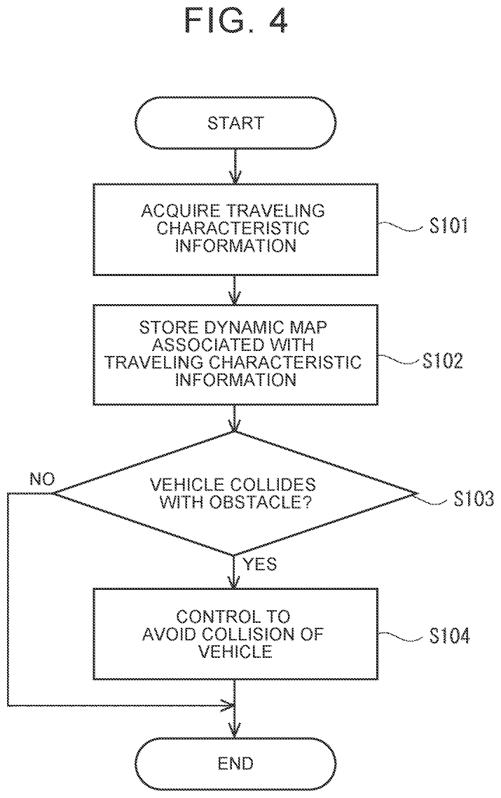

Next will be described a driving support method according to the present embodiment. FIG. 4 is a flowchart illustrating the procedure of the driving support method according to the present embodiment. Note that the control process illustrated in FIG. 4 is executed repeatedly for every predetermined time.

The communication portion 41 of the control server 4 acquires traveling characteristic information on the vehicle 2 (step S101).

The storage portion 42 of the control server 4 stores a dynamic map in which static base map information, dynamic environmental information, and the traveling characteristic information acquired by the communication portion 41 are associated with each other (step S102).

The collision determination portion 44 of the control server 4 determines whether or not there is a possibility that the vehicle 2 may collide with an obstacle, based on the dynamic map stored in the storage portion 42 (step S103).

In a case where the collision determination portion 44 determines that there is a possibility that the vehicle 2 may collide with an obstacle (YES in step S103), the controlling portion 45 of the control server 4 controls the vehicle 2 such that the vehicle 2 avoids the collision (step S104). In the meantime, in a case where the collision determination portion 44 determines that there is no possibility that the vehicle 2 may collide with an obstacle (NO in step S103), the controlling portion 45 of the control server 4 ends this process.

Note that, in the above embodiment, the control server 4 includes the collision determination portion 44 and the controlling portion 45. However, the present disclosure is not limited to this. For example, the ECU 22 of the vehicle 2 may include the collision determination portion 44 and the controlling portion 45.

In this case, the map update portion 43 of the control server 4 updates the dynamic map and transmits the updated dynamic map to the ECU 22 of the vehicle 2. The collision determination portion 44 of the ECU 22 determines whether or not there is a possibility that the vehicle 2 may collide with an obstacle, based on the dynamic map transmitted from the control server 4. In response to the determination result from the collision determination portion 44, the controlling portion 45 of the ECU 22 controls the vehicle 2 such that the vehicle 2 avoids the collision.

Thus, the driving support system 1 according to the present embodiment determines whether or not there is a possibility that the vehicle 2 may have a collision, based on the dynamic map in which static base map information, dynamic environmental information, and traveling characteristic information on the vehicle 2 are associated with each other, and in a case where the driving support system 1 determines that there is a possibility that the vehicle 2 may have a collision, the driving support system 1 controls the vehicle 2 such that the vehicle 2 avoids the collision. Hereby, it is possible to determine a collision of the vehicle 2 with high accuracy and to enhance safety in consideration of the traveling characteristic of the vehicle 2.

Some embodiments of the present disclosure have been described above, but these embodiments are merely described as examples and are not intended to limit the scope of the disclosure. These new embodiments can be performed in other various configurations, and various omissions, substitutions, modifications can be performed without departing from the gist of the disclosure. These embodiments and the modifications thereof are included in the scope and summary of the disclosure and are included within the disclosure described in Claims and their equivalent ranges.

For example, the present disclosure can be achieved by causing a processor to execute a computer program to execute the process illustrated in FIG. 4.

The program can be stored by use of various types of non-transitory computer readable media and supplied to the computer. The non-transitory computer readable media include various types of tangible storage media. Examples of the non-transitory computer readable media include magnetic recording media (e.g., a flexible disk, a magnetic tape, a hard disk drive), optical magnetic recording media (e.g., a magneto-optical disk), a CD read-only memory (CD-ROM), a CD-R, a CD-R/W, and a semiconductor memory (e.g., a mask ROM, a programmable ROM (PROM), an erasable PROM (EPROM), a flash ROM, and a random access memory (RAM)).

The program can be supplied to the computer by various types of transitory computer readable media. Examples of the transitory computer readable media include an electrical signal, an optical signal, and an electromagnetic wave. The transitory computer readable media can supply the program to the computer via a wired communication channel such as an electric wire or an optical fiber, or a wireless communication channel.

Each portion constituting the control server 4 according to the embodiment can be implemented by a program or can be also partially or fully implemented by dedicated hardware such as an application specific integrated circuit (ASIC) or a field-programmable gate array (FPGA).

What is claimed is:

1. A driving support system comprising:
an information acquisition unit configured to acquire traveling characteristic information on a vehicle;
a storage unit in which a dynamic map is stored, the dynamic map being a map in which static base map information, dynamic environmental information, and the traveling characteristic information acquired by the information acquisition unit are associated with each other;
a collision determination unit configured to determine whether or not there is a possibility that the vehicle has a collision, based on the dynamic map stored in the storage unit; and
a control unit configured to, in a case where the collision determination unit determines that there is a possibility that the vehicle has a collision, control the vehicle such that the vehicle avoids the collision.

2. The driving support system according to claim 1, wherein the traveling characteristic information includes at least one of information indicative of whether or not the vehicle has a deceleration control function, a maximum deceleration speed of the vehicle, an idle running time of the vehicle, information indicative of whether or not the vehicle has a steering control function, and a minimum turning radius of the vehicle.

3. The driving support system according to claim 1, wherein:
the traveling characteristic information includes information indicative of whether or not the vehicle has a deceleration control function, a maximum deceleration speed of the vehicle, and information indicative of whether or not the vehicle has a steering control function;
the collision determination unit determines whether or not a first vehicle avoids a collision with a second vehicle by performing a deceleration control, by use of an equation including the maximum deceleration speed of the vehicle based on the dynamic map associated with the traveling characteristic information;
in a case where the collision determination unit determines that the first vehicle does not avoid the collision with the second vehicle by performing the deceleration control, the control unit performs a steering control on the first vehicle such that the first vehicle avoids the second vehicle, based on the traveling characteristic information.

4. A driving support method comprising:
a step of acquiring traveling characteristic information on a vehicle;
a step of storing a dynamic map in which static base map information, dynamic environmental information, and the traveling characteristic information are associated with each other;
a step of determining whether or not there is a possibility that the vehicle has a collision, based on the dynamic map thus stored; and
a step of, in a case where it is determined that there is a possibility that the vehicle has a collision, controlling the vehicle such that the vehicle avoids the collision.

5. A non-transitory storage medium storing a program to cause a computer to execute the following processes:
a process of acquiring traveling characteristic information on a vehicle;
a process of storing a dynamic map in which static base map information, dynamic environmental information, and the traveling characteristic information are associated with each other;
a process of determining whether or not there is a possibility that the vehicle has a collision, based on the dynamic map thus stored; and
a process of, in a case where it is determined that there is a possibility that the vehicle has a collision, controlling the vehicle such that the vehicle avoids the collision.
